(19) United States
(12) Patent Application Publication
(10) Pub. No.: US 2024/0004062 A1
(43) Pub. Date: Jan. 4, 2024

(54) GEOGRAPHICALLY AUGMENTED SONAR

(71) Applicant: NAVICO HOLDING AS, Egersund (NO)

(72) Inventor: Alan P. Davis, Winchester (GB)

(21) Appl. No.: 17/856,205

(22) Filed: Jul. 1, 2022

(51) Int. Cl. G01S 15/89; G01C 13/00; G01S 7/52

(52) U.S. Cl. CPC G01S 15/89; G01C 13/008; G01S 7/52053

(57) ABSTRACT

A system for presenting marine data is provided herein. At least one sonar transducer is configured to emit one or more sonar beams into an underwater environment of a body of water in a direction relative to a watercraft. The system comprises a display, processor and memory including computer program code. The code is configured to, when executed, cause the processor to determine a location associated with travel of the watercraft, and determine a depth of the body of water at the location. The system determines a power output for emitting the sonar beams and emits the sonar beams at the power output such that the sonar transducer receives sonar returns at the depth. The system generates a sonar image corresponding to the sonar returns received by the sonar transducer, and causes, on the display, presentation of the sonar image.

### FIELD OF THE INVENTION

Embodiments of the present invention generally relate to marine data, and more particularly, to generating a continuous sonar image over a broad range of depth changes using known geography of a marine environment.

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. In this regard, due to the extreme limits to visibility underwater, sonar is typically the most accurate way to locate objects underwater. Sonar transducer elements, or simply transducers, may convert electrical energy into sound or vibrations at a particular frequency. A sonar sound beam is emitted at a determined power output and transmitted into and through the water. The sound beam is reflected from objects it encounters (e.g., fish, structure, bottom surface of the water, etc.). The transducer may receive the reflected sound (the “sonar returns”) and convert the sound energy into electrical energy. Based on the known speed of sound, it is possible to determine the distance to and/or location of the waterborne or underwater objects. However, when the power output is too large the reflected sound may scatter, and when the power output is too small the sonar sound beam may be lost before reflecting off an object, thus, generating inaccuracies or gaps in sonar images.

The sonar return signals can also be processed to be presented on a display, giving the user a “picture” or image of the underwater environment. Notably, however, if the power output of the sonar beam is emitted at a frequency too high or too low for the depth, the sonar beams may not reflect off of the bottom surface of the body of water in a desirable way, such that an informative sonar image of the underwater environment is not produced.

### BRIEF SUMMARY OF THE INVENTION

As noted above, the power output of a sonar transducer should correspond to the depth of the body of water, otherwise it can be difficult to produce a reliable complete sonar image of the underwater environment. This is particularly challenging over sudden depth changes, upon powering up a sonar system or when the sonar signal is disrupted. Traditionally, sonar systems gradually increase the power emitted from the sonar transducer until a bottom lock is formed, where at least a portion of the one or more sonar beams reach and reflect off of the bottom surface of the body of water. The bottom lock may be lost when the watercraft travels over sudden depth changes, which may lead to gaps and/or inaccuracies in the sonar image, as the sonar system incrementally increases the power output until an echo is received.

In an example embodiment of the present invention, a system for presenting marine data is provided. The system comprises at least one sonar transducer associated with a watercraft. The at least one sonar transducer is configured to emit one or more sonar beams into an underwater environment of a body of water in a direction relative to the watercraft. The system further comprises a display, a processor and a memory including a computer program code. The computer program code is configured to, when executed, cause the processor to determine a location associated with travel of the watercraft, and determine a stored depth or an estimated depth of the body of water at the location. The computer program code is further configured to, when executed, cause the processor to determine, based on the stored depth or the estimated depth, a power output to apply for emitting the one or more sonar beams such that the at least one sonar transducer receives sonar returns from a bottom of the body of water, and emit the one or more sonar beams at the determined power output. The computer program code is further configured to, when executed, cause the processor to receive sonar return data corresponding to the sonar returns received by the at least one sonar transducer, generate, based on the sonar return data, a sonar image corresponding to the sonar returns received by the at least one sonar transducer, and cause, on the display, presentation of the sonar image.

In some embodiments, the location associated with the travel of the watercraft may be a current location of the watercraft. In some embodiments, the location associated with travel of the watercraft may be an anticipated location of the watercraft. In some embodiments, the anticipated location of the watercraft may be a waypoint along a route of travel. In some embodiments, the location associated with travel of the watercraft may be updated after a determining event. In some embodiments, the determining event may be one of a time interval or a distance traveled.

In some embodiments, the stored depth may be gathered from at least one of a depth chart, an online database, or a prior depth reading. In some embodiments, the estimated depth may be estimated based on a first known depth at a first location and a second known depth at a second location, wherein the location associated with a direction of travel may be between the first known location and the second known location.

In some embodiments, the at least one sonar transducer may be configured to emit one or more sonar beams at a range of power outputs. In some embodiments, the computer program code may be further configured to, when executed, cause the processor to receive the stored depth or the estimated depth, and determine based on the range of power outputs of the at least one sonar transducer, the power output corresponding to the stored depth, or the estimated depth, such that the one or more sonar beams emitted are configured to reach the bottom of the body of water and return to the at least one sonar transducer.

In some embodiments, the computer program code may be further configured to, when executed, cause the processor to store the determined power output corresponding to the stored depth or the estimated depth in a power output chart.

In some embodiments, the computer program code may be further configured to, when executed, cause the processor to determine sonar returns have not been received after a period of time, and increase the determine power output. In some embodiments, the period of time may be between 1-8 seconds.

In another example embodiment, a method for presenting marine data is provided. The method comprises determining a location associated with travel of a watercraft. The watercraft including at least one sonar transducer configured to emit one or more sonar beams into an underwater environment of a body of water in a direction relative to the watercraft. The method further comprises determining a stored depth or an estimated depth of the body of water at the location and determining based on the stored depth of the estimated depth, a power output to apply for emitting the one or more sonar beams such that the at least one sonar transducer receives sonar returns from a bottom of the body of water. The method continues by emitting the one or more sonar beams at the determined power output, generating, based on the sonar return data, a sonar image corresponding to the sonar returns received by the at least one sonar transducer, and causing on the display presentation of the sonar image.

In some embodiments, the location associated with the travel of the watercraft may be a current location of the watercraft. In some embodiments, the location associated with travel of the watercraft may be an anticipated location of the watercraft. In some embodiments, the anticipated location of the watercraft may be a waypoint along a route of travel.

In some embodiments, the method may further comprise associating the determined power output with the location associated with travel of the watercraft and storing the associated determined power output into a navigational chart.

In yet another example embodiment, a marine electronics device for a watercraft is provided. The watercraft includes at least one sonar transducer configured to emit one or more sonar beams into an underwater environment of a body of water in a direction relative to the watercraft. The marine electronics device comprising a display, a processor, and a memory including a computer program code. The computer program code is configured to, when executed, cause the processor to determine a location associated with travel of the watercraft, and determine a stored depth or an estimated depth of the body of water at the location. The computer program code is further configured to, when executed, cause the processor to determine, based on the stored depth or the estimated depth, a power output to apply for emitting the one or more sonar beams such that the at least one sonar transducer receives sonar returns from a bottom of the body of water, and emit the one or more sonar beams at the determined power output. The computer program code is further configured to, when executed, cause the processor to receive sonar return data corresponding to the sonar returns received by the at least one sonar transducer, generate, based on the sonar return data, a sonar image corresponding to the sonar returns received by the at least one sonar transducer, and cause, on the display, presentation of the sonar image.

In some embodiments, the location associated with travel of the watercraft is an anticipated location of the watercraft.

### BRIEF DESCRIPTION OF THE DRAWINGS

Having thus described the invention in general terms, reference will not be made to the accompanying drawings, which are not necessarily drawn to scale, and wherein:

FIG. 1 illustrates an example watercraft including various marine devices, in accordance with some embodiments discussed herein;

FIGS. 2A-C illustrates example sonar beams emitted from a sonar transducer, wherein the sonar beams echo off of the bottom surface of the bottom of water, wherein the bottom surface defines a gradual slope;

FIG. 2D illustrates an example display presenting a composite sonar image corresponding to the sonar beam echoes illustrated in FIGS. 2A-C, in accordance with some embodiments discussed herein;

FIG. 3A illustrates example sonar beams emitted from a sonar transducer over a change in depth, wherein the power output of the sonar transducers are adjusted until reaching the bottom surface of the underwater environment, in accordance with some embodiments discussed herein;

FIG. 3B illustrates an example display presenting a composite sonar image corresponding to the sonar beam echoes illustrated in FIG. 3A, in accordance with some embodiments discussed herein;

FIGS. 4A-B illustrates an example display presenting a bathymetric chart with a route of travel overlaid, in accordance with some embodiments discussed herein;

FIG. 5 illustrates an example watercraft having two sonar transducers configured to emit one or more sonar beams at different frequencies, in accordance with some embodiments discussed herein;

FIG. 6A illustrates example sonar beams emitted from an example geographically augmented sonar system, wherein the power outputs are adjusted upon geographic location, in accordance with some embodiments discussed herein;

FIG. 6B illustrates an example display presenting a composite sonar image corresponding to the sonar beam echoes illustrated in FIG. 6A, in accordance with some embodiments discussed herein;

FIG. 7 illustrates a block diagram of an example system with various electronics devices, marine devices, and secondary devices shown, in accordance with some embodiments discussed herein; and

FIG. 8 illustrates a flow chart of an example method for presenting marine data corresponding to geographically augmented sonar system, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

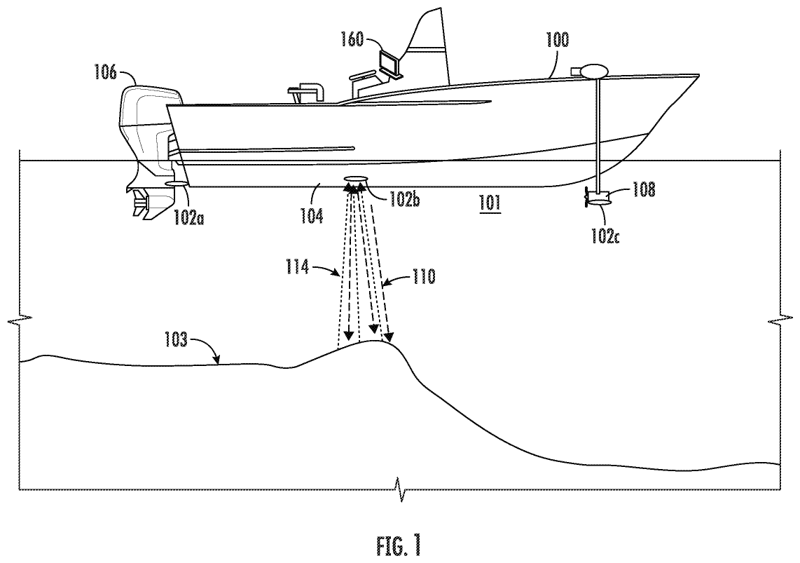

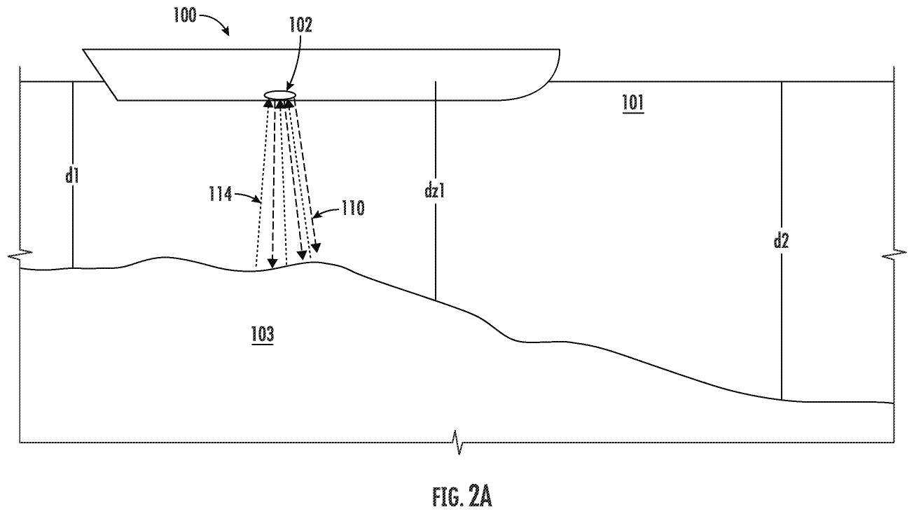

FIG. 1 illustrates an example watercraft 100 including various marine devices, in accordance with some embodiments discussed herein. As depicted in FIG. 1, the watercraft 100 is configured to traverse a marine environment, e.g., a body of water 101, and may use one or more sonar transducers 102a, 102b, 102c disposed on and/or proximate to the watercraft. Notably, example watercrafts contemplated herein may be surface watercrafts, submersible watercrafts, or any other implementation known to those skilled in the art. The sonar transducers 102a, 102b, 102c may each include one or more transducer elements configured to emit one or more sonar beams 110 into an underwater environment of a body of water 101 in a direction relative to the watercraft 100, receive sonar returns 114 from one or more echoes of the one or more sonar beams 110 emitted, and convert the sonar returns 114 into sonar return data. Various types of sonar transducers may be utilized—for example, a linear downscan sonar transducer, a conical downscan sonar transducer, a sonar transducer array, an assembly with multiple transducer arrays, or a sidescan sonar transducer may be used.

Depending on the configuration, the watercraft 100 may include a primary motor 106, which may be a main propulsion motor such as an outboard or inboard motor. Additionally, the watercraft 100 may include a trolling motor 108 configured to propel the watercraft 100 or maintain a position. The one or more sonar transducers (e.g., 102a, 102b, 102c) may be mounted in various positions and to various portions of the watercraft 100 and/or equipment associated with the watercraft 100. For example, the sonar transducer may be mounted to the transom of the watercraft 100 such as depicted by sonar transducer 102a. In some embodiments, the sonar transducer may be mounted to the bottom or side of the hull 104 of the watercraft 100, such as depicted by sonar transducer 102b. In some embodiments, the sonar transducer may be mounted to the trolling motor 108 such as depicted by sonar transducer 102c.

The watercraft 100 may also include one or more marine electronic devices 160, such as may be utilized by a user to interact with, view, or otherwise control various functionality regarding the watercraft, including, for example, nautical charts and various sonar systems described herein. In the illustrated embodiment, the marine electronics device 160 may be positioned proximate the helm (e.g., steering wheel) of the watercraft 100—although other places on the watercraft 100 are contemplated. Likewise, additionally or alternatively, a remote device (such as a user's mobile device) may include functionality of a marine electronics device.

As illustrated the one or more sonar beams 110 produce sonar returns 114 when the one or more sonar beams 110 reflect or echo off of a surface for example, the bottom surface 103 of the body of water 101, a vessel, a fish, or other object within the body of water. Sonar transducers (e.g., 102a, 102b, 102c) are configured to operate at varying power outputs. An example range of power outputs for operation is 50 Watts to 3,000 Watts, although other power outputs are contemplated. Generally, when a sonar transducer is turned on, the sonar transducer will begin to operate at a lower power output, thus producing a shorter sonar beam (with less sound energy being produced). Thus, if the power output is too small and the sonar beam does not reach an object to reflect off of, a sonar return is not produced. Moreover, in some cases, a lack of power may still lead to creation of a sonar return, but that sonar return may not be received by the sonar transducer. In contrast, if the power output is too large the sonar beam may scatter upon reaching and reflecting off of the object thereby producing “noise” within the sonar returns. Thus, when initiating operation of a sonar transducer, the sonar beams are generally emitted at a lower power output and gradually increased until the bottom surface 103 or other object is detected. Similarly, sonar transducers may be configured to start at the last used power output, if the bottom surface 103 is lost, and may take several incremental increases to reach the power output which will produce one or more sonar beams that reach the bottom surface 103.

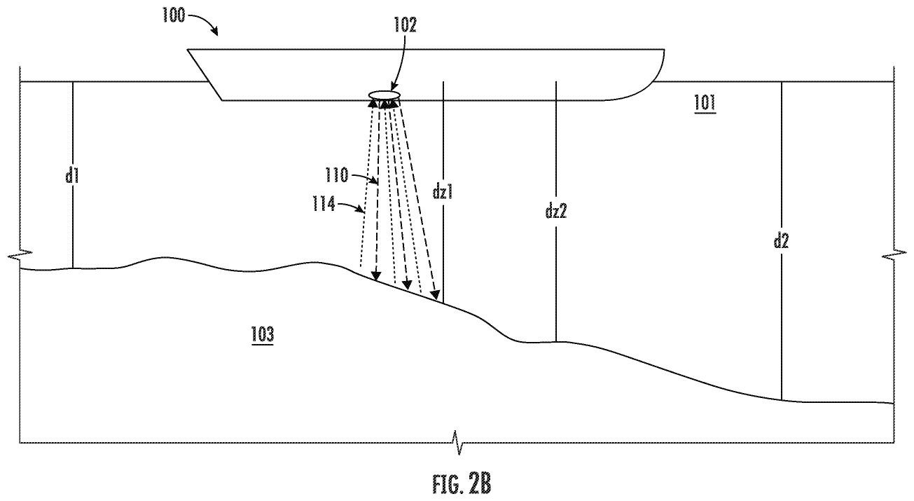

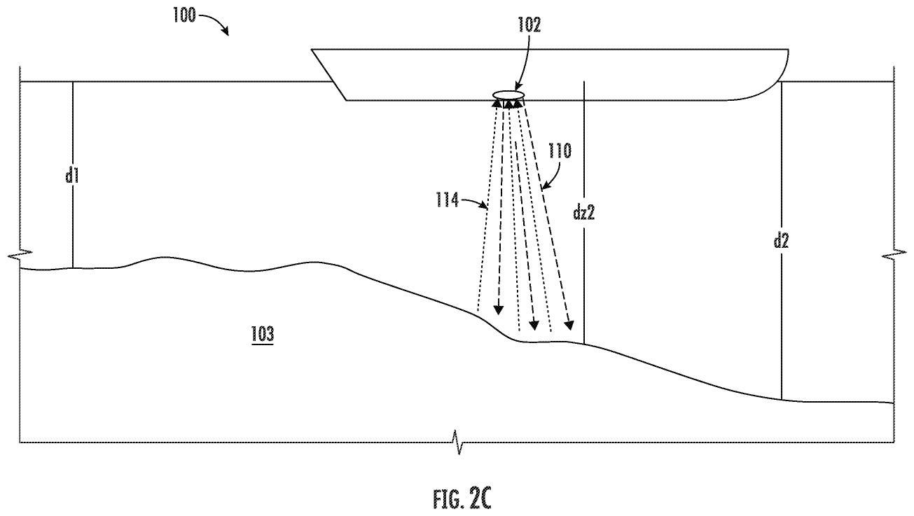

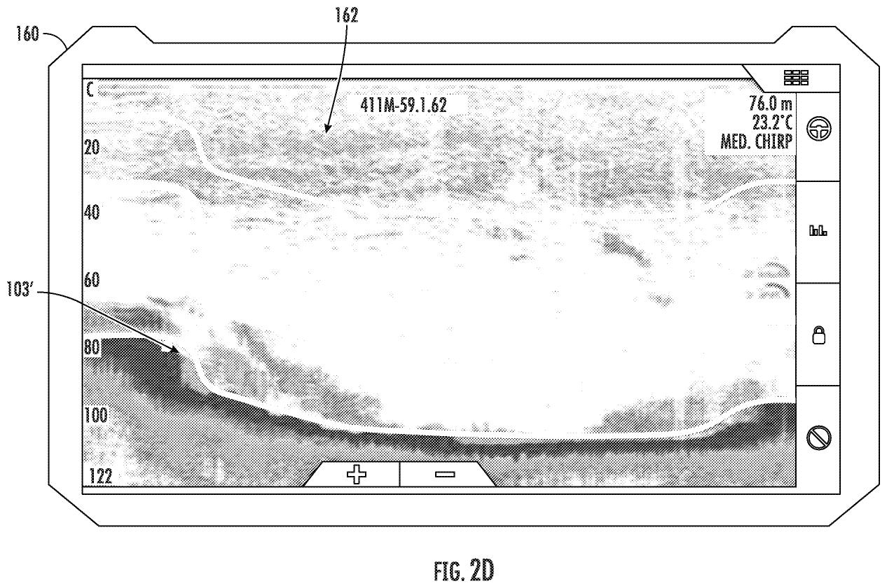

FIGS. 2A-C illustrate the watercraft 100 traversing the body of water 101, where the bottom surface 103 defines a gradual slope between a first depth d₁ and a second depth d₂. Said differently, FIG. 2A illustrates the watercraft 100 at a first position defining the first depth d₁. FIG. 2B illustrates the watercraft 100 at a second position defining a first intermediate depth d_{z1}. FIG. 2C illustrates the watercraft 100 at a third position defining a second intermediate depth d_{z2} approaching the second depth d₂.

In reference to FIG. 2A, at the first position, the sonar transducer 102 emits one or more sonar beams 110 at a first power output. The one or more sonar beams 110 reflect off of the bottom surface 103 generating the sonar returns 114 which are received at the sonar transducer 102. As discussed above, sonar beams are emitted at a determined power output based on the depth of the water (e.g., between the surface of the body of water and the bottom surface of the body of water). Thus, a greater power output is needed for a greater depth. In instances when the bottom surface 103 is about constant, or changes depths within the sonar beams 110 power output range, the sonar beams 110 may be emitted at a constant power output and reach the bottom surface 103. In instances where the bottom surface 103 changes at a gradual slope, the sonar transducer may only need to perform one or a few, if any, power output iterations (e.g., increases or decreases) to maintain a bottom lock on the bottom surface 103 such that the sonar transducer 102 receives the sonar returns 114 generated by the one or more sonar beams 110. Such a few iterations may not be noticeable on any produced sonar image.

As illustrated in FIG. 2B as the watercraft 100 traverses the body of water 101 the depth (e.g., distance between the surface of the water and the bottom surface 103) gradually increases. Thus, as the watercraft 100 moves from the first position at the first depth d₁ to the second position at the first intermediate depth d_{z1} the system may be able to acquire depth data at each position such that the system may adjust the power output, such that the one or more sonar beams 110 reach and are reflected off of the bottom surface 103—thereby generating sonar returns received by the sonar transducer. Thus, as illustrated in FIGS. 2B-C, the watercraft 100 may emit the one or more sonar beams 110 at a determined power output such that the bottom lock is retained along the traverse from the first position at the first depth d₁ to a fourth position at the second depth d₂.

In some embodiments, maintaining a bottom lock may allow the system to generate and display a continuous sonar image. FIG. 2D illustrates the marine electronics device 160 presenting a sonar image 162. The sonar image 162 may be a compilation of sonar return image portions from the sonar transducer, wherein each sonar image portion may be configured as a vertical slice that leads from a zero depth vertically down to a second non-zero depth. In some embodiments, the zero depth may be the surface of the water, while in other embodiments the zero depth may be the height of the transducer when the transducer is under the surface of the water. The second non-zero depth may correspond to (and/or include) the bottom surface 103′ of the body of water.

The sonar transducer may continuously, or incrementally, receive sonar return data, as such, the sonar images presented on the display may continuously update. The system may generate a first subsequent sonar image portion from subsequent sonar return data received at the sonar transducer. The subsequent image portion may be used to update the sonar image portion, by moving the sonar image portion left and placing the subsequent sonar image portion adjacent to the sonar image portion that was just moved (e.g., creating a “waterfall” image).

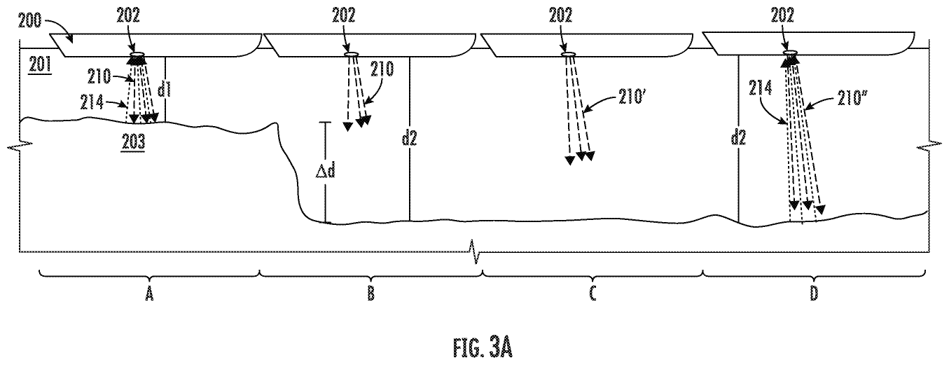

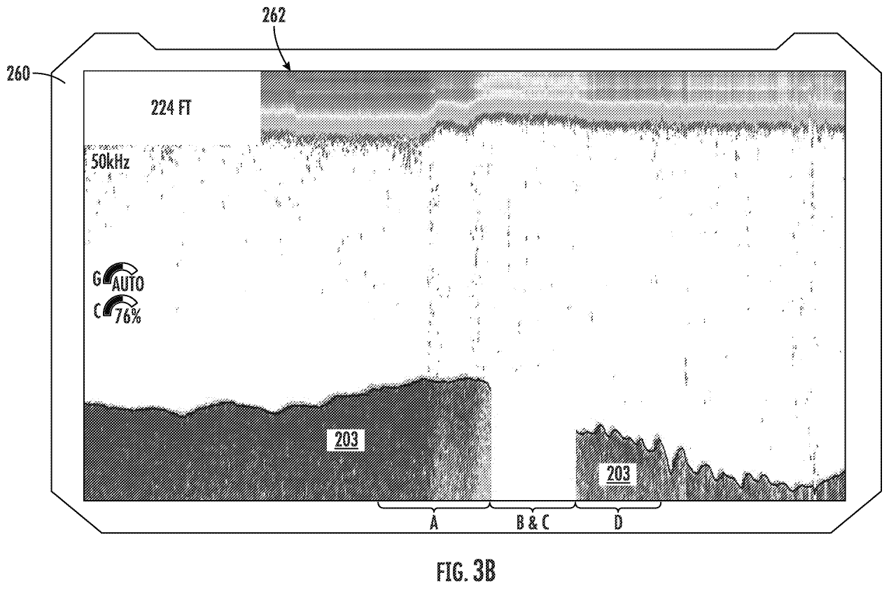

However, the sonar transducer may periodically lose the bottom lock, and thus, not receive sonar returns to generate the sonar image portion (e.g., due to, for example, sudden depth changes, depth information loss, heavy turbulence, sonar signal interruption, etc.). The system may adjust the power output of the sonar transducer until the sonar transducer receives sonar returns and generates a slice of the sonar image. For example, as illustrated in FIG. 3A, a watercraft 200 may traverse a body of water 201 defining a sudden depth change Δd along a bottom surface 203 of the body of water 201. In some embodiments, a sonar transducer 202 may emit one or more sonar beams 210 into the underwater environment and receive sonar returns 214 generated by the one or more sonar beams 210 echoing off of the bottom surface 203 at a first position of the body of water 201 defining a first depth d₁. The watercraft 200 may traverse across the sudden depth change Δd, such that the depth of the body of water 201 at a second position of the watercraft 200 is a second depth d₂.

In some embodiments, the power output of the sonar transducer 202 at the first depth d₁ is too low to reach the bottom surface 203 at the second depth d₂. As depicted in section B, the sonar transducer 202 may emit the one or more sonar beams 210 at the same power output as the first depth d₁, however, the one or more sonar beams 210 do not reach the bottom surface 203 and, thus, no sonar returns are received. The system may incrementally increase the power output of the sonar transducer 202 until the power output is great enough to reach the bottom surface 203.

For example, in some embodiments, the system may increase the power output after not receiving sonar returns within 50 milliseconds, while in other embodiments, the power output may be increased after not receiving sonar returns within 1 second, although other time periods are contemplated (e.g., within 10 milliseconds, within 30 milliseconds, within 100 milliseconds, within 200 milliseconds, within 500 milliseconds, within 700 milliseconds, within 2 seconds, etc.). In some embodiments, the system may increase the power output after a determined distance when sonar returns are not received. For example, the system may increase the power output after 20 feet, after 100 feet, or after 500 feet. In some embodiments, the determined distance may be correlated to the speed of the watercraft 200 (e.g., a watercraft moving at a higher speed may allow a greater distance without receiving sonar returns between power output increases).

Thus, as illustrated in section C, the power output supplied by the sonar transducer 202 to produce the one or more sonar beams 210′ may increase by a first iteration and may not reach the bottom surface 203. The system may increase the power output of the sonar transducer 202 until the one or more sonar beams 210″ reach and echo off of the bottom surface 203 to generate sonar returns 214.

However, during the traverse along the body of water 201 from the sudden depth change Δd until the watercraft reacquires a bottom lock on the bottom surface 203, the sonar system may not be producing sonar image portions. Thus, with reference to FIG. 3B, where a marine electronics device 260 is presenting a sonar image 262, the sonar transducer lost the bottom lock on the bottom surface during sections B and C, which is reflected by the blank section of the sonar image 262. The lack of continuity within the sonar image, may make the image less desirable, inaccurate, and/or may be hard for a user to read.

Thus, it may be desirable to use a stored depth or an estimated depth to determine the power output of a sonar transducer such that the one or more sonar beams will produce and receive sonar returns—thereby generating a continuous sonar image, thereby increasing reliability and confidence in the sonar system.

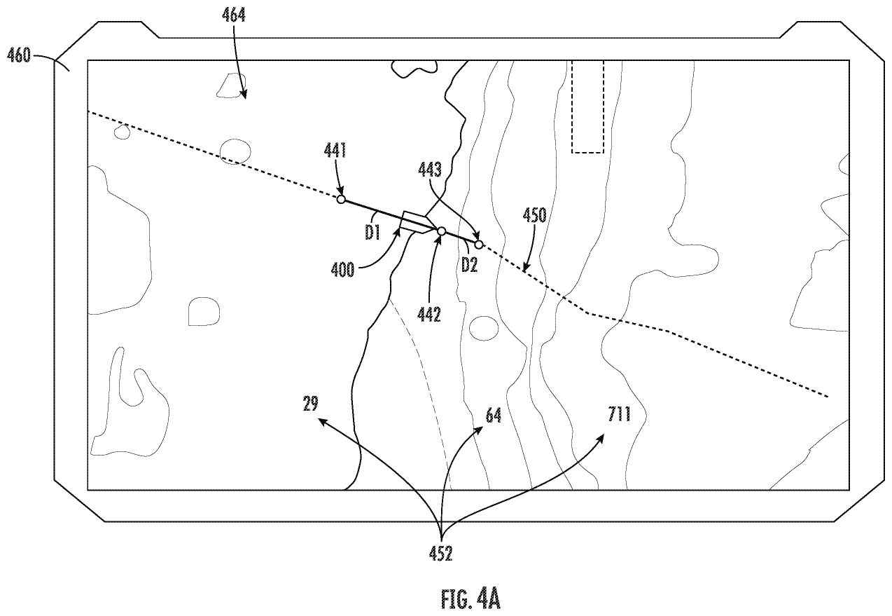

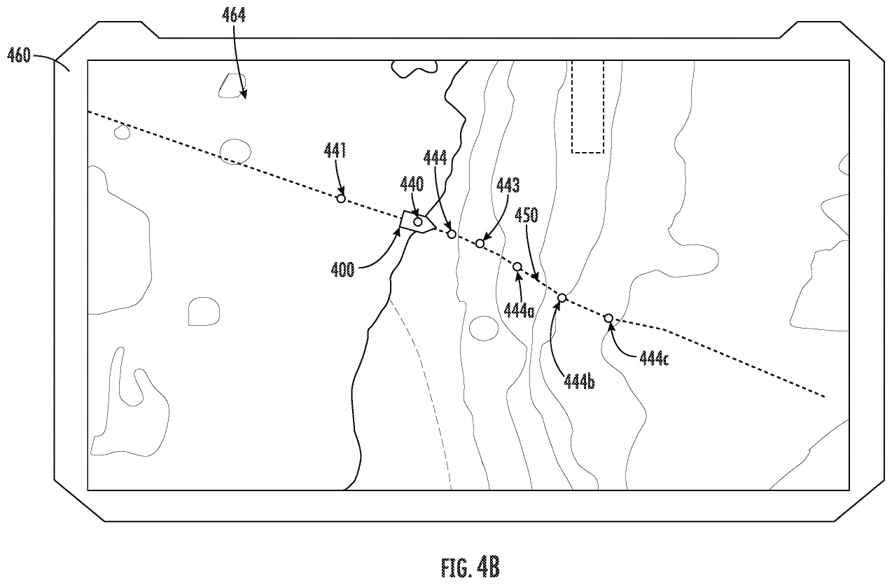

To explain, FIGS. 4A-B illustrate a marine electronics device 460 presenting a chart 464 of the current location of the watercraft 400. In some embodiments, the chart 464 may be a bathymetric chart, a navigational chart, or other chart configured to present marine data. In some embodiments, chart 464 may be used to store data corresponding to the marine environment. In some embodiments, the chart 464 may present data, including a stored depth 452. As illustrated in FIG. 4A, the chart 464 displays stored depths 452 across the chart. In some embodiments, the stored depths may be gathered from at least one of a depth chart, an online database, a prior depth reading, or other method of gathering depth data. In some embodiments, the depth data may correspond to a tidal station in the body of water.

In some embodiments, depth data may not be available for the entire area of the body of water. Thus, in some embodiments, the depth at any point may be an estimated depth. In some embodiments, the estimated depth may be based on a first known depth (e.g., 27 ft) at a first known location 441 and a second known depth (e.g., 69 ft) at a second known location 443. In some embodiments, each of the first known location 441 and the second known location 443 may correlate to stored depths (e.g., 452) within the chart 464. The depth of a location 442 associated with travel of the watercraft 400 may be determined utilizing the first known position 441 and the second known position 443 and the respective depths. In some embodiments, the depth may be estimated by averaging the first known depth and the second known depth. In some embodiments, the depth may be estimated by taking a weighted average of the first known depth and the second known depth.

To explain, in an example embodiment, the first known position 441 may be a first distance D₁ from the location 442 associated with travel of the watercraft 400, and the second known position 443 may be a second distance D2 away from the location 442 associated with travel of the watercraft 400. The depth at the location 442 may be estimated using the first distance D₁, the first known depth, the second distance D2 and the second known depth. Thus, if the location 442 associated with travel of the watercraft 400 is closer to the second known position, the depth at the location 442 may be closer to the second known depth at the second known location 443.

In some embodiments, the depth may be estimated by triangulating the depth. For example, the system may utilize the first known depth at the first known location 441 and the second known depth at the second known location 443 and may utilize one or more other known depths at known locations and the distance from the known depth to the location associated with travel of the watercraft for a more accurate estimation of the depth of the body of water 401 at the location 442 associated with travel of the watercraft 400.

In some embodiments, the depth at the location associated with travel of the watercraft may determine the power output of the sonar transducer associated with the watercraft as discussed above. For example, one or more look up tables or databases may be queried to determine an appropriate power output to apply to the sonar transducer for the stored or estimated depth at the location.

In some embodiments, the location 442 associated with travel of the watercraft 400 may be a current location 440 of the watercraft 400, as illustrated in FIG. 4B. In some embodiments, the current location 440 of the watercraft 400 may be determined by a positioning sensor such as a Global Positioning Sensor (GPS).

In some embodiments, the location 442 associated with travel of the watercraft 400 may be an anticipated location 444. For example, the anticipated location 444 may be a waypoint along a route of travel 450. In some embodiments, the depth at the anticipated location 444 may be a stored depth, while in other embodiments the depth at the anticipated location 444 may be estimated based on other known depths, as discussed above. In some embodiments, the anticipated location 444 may be updated after the current location 440 of the watercraft is within a threshold distance of the anticipated location 444. In some embodiments, the threshold distance may correlate to the speed of the boat, and/or the size of the boat. For example, in a larger watercraft the threshold distance may be greater than the threshold distance for a smaller watercraft. In some embodiments, the threshold distance may be at least 10 ft, at least 100 ft, or at least 500 ft. In some embodiments, the threshold distance may correspond to the distance traveled over a power output iteration.

In some embodiments, the anticipated location may be updated (e.g., 444a, 444b, 444c) after a determining event. In some embodiments, the determining event may be a time interval. For example, the time interval may be 10 milliseconds, 30 milliseconds, 50 milliseconds, 100 milliseconds, 200 milliseconds, 500 milliseconds, 1 second, 5 seconds, etc. In some embodiments, the time interval may correspond to the speed of the watercraft (e.g., a watercraft moving at a higher speed may have a larger time interval). In some embodiments, the determining event may be a distance traveled by the watercraft. In some embodiments, the anticipated location 444 may be updated after the watercraft travels 10 ft, 50 ft, 100 ft, 500 ft, or other distance traveled. Similarly, as discussed above, the distance traveled may be correlated to the speed of the watercraft, and/or the distance the watercraft travels over a power output iteration.

In some embodiments, the stored depth and/or the estimated depth may be adjusted to account for the tidal stage of the body of water. For example, tidal data may be obtained from the nearest tidal station to determine the stage of the tide (e.g., high tide, low tide) within the cycle. In some embodiments, the tidal range may be between 2 feet-56 feet. The tidal range may be greater closer to coast and/or in shallower waters, and thus, may be beneficial to account for. In some embodiments, the depth, either stored or estimated, may be based on a median tide (e.g., between high tide and low tide) and may be corrected based on the stage of the tide.

After determining the depth of the location 444 associated with travel of the watercraft 400 the system may determine a power output for the sonar transducer to emit the one or more sonar beams such that the at least one sonar transducer receives sonar returns. In some embodiments, the determined power output may be stored within a database. In some embodiments, the determined power output may be correlated to bathymetric chart such that the system may directly pull the determined power output rather than calculate the power output for future trips along the same and/or a similar route.

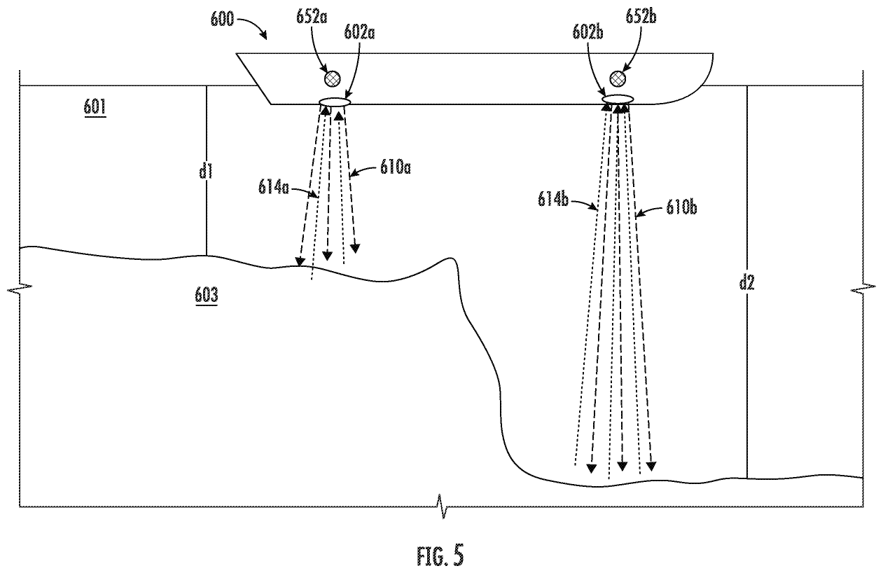

Some watercraft may utilize multiple sonar transducers, each with different power output ranges corresponding to varying depth ranges. This may occur, for example, when the watercraft is configured to traverse a wide depth range (e.g., from shore into the ocean). In some embodiments, with reference to FIG. 5, a watercraft 600 may have a first sonar transducer 602a and a second sonar transducer 602b. Each of the first sonar transducer 602a and the second sonar transducer 602b may be configured to emit one or more sonar beams 610a, 610b into an underwater environment of a body of water 601 in a direction relative to the watercraft 600. In some embodiments, the first sonar transducer 602a may emit one or more sonar beams 610a at a first power output range, and the second sonar transducer 602b may emit one or more sonar beams 610b at a second power output range. Thus, the first sonar transducer 602a and the second sonar transducer 602b may be configured for different depths of water. For example, in an embodiment the first sonar transducer 602a may be configured for shallow water, while the second sonar transducer 602b may be configured for deeper water, or vice versa. In some embodiments, the first power output range and the second power output range may overlap, while in other embodiments, the first power output range may be distinct from the second power output range.

In some embodiments, the system may emit one or more sonar beams 610a, 610b from both the first sonar transducer 602a and the second sonar transducer 602b, and receive sonar returns 614a, 614b at the respective sonar transducer, when the depth is within the power output range. In some embodiments, the system may utilize either the stored depth, or an estimated depth to determine the requisite power output such that the one or more sonar beams 610a, 610b reach a bottom surface 603 of the body of water 601. Using the determined power output, the system may choose either the first power output range or the second power output range corresponding to the first sonar transducer 602a or the second sonar transducer 602b to emit the one or more sonar beams 610a, 610b to reach the bottom surface 603. Thus, as illustrated in FIG. 5, when the watercraft 600 is at a first position 652a, the chosen sonar transducer may be the first sonar transducer 602a emitting the one or more sonar beams 610a at a first power output range to reach a first depth d₁, while when the watercraft 600 is at a second position 652b the chosen sonar transducer may be the second sonar transducer 602b emitting the one or more sonar beams 610b at the second power output range to reach a second depth d₂.

In some embodiments, the sonar transducer may be configured to emit one or more sonar beams at a power output range. Thus, the system may, using either the stored depth or the estimated depth, determine the power output necessary for the one or more sonar beams to reach the bottom surface. Once the power output is determined, the system may determine the power output chosen from the power output range to emit the one or more sonar beams at such that the one or more sonar beams reach the bottom surface and generate sonar returns that are received by the appropriate sonar transducer.

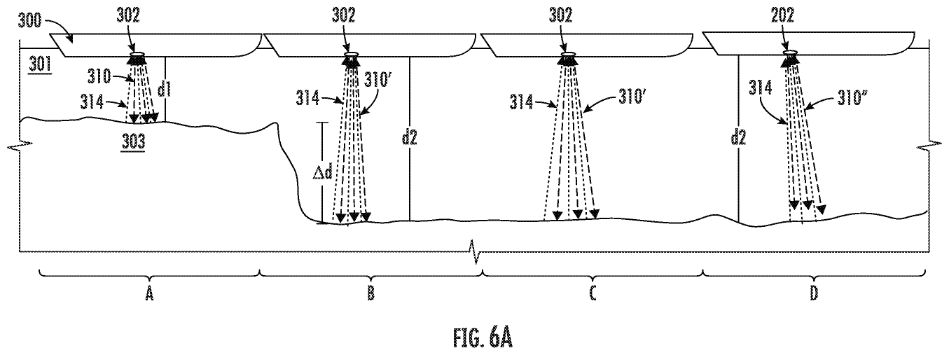

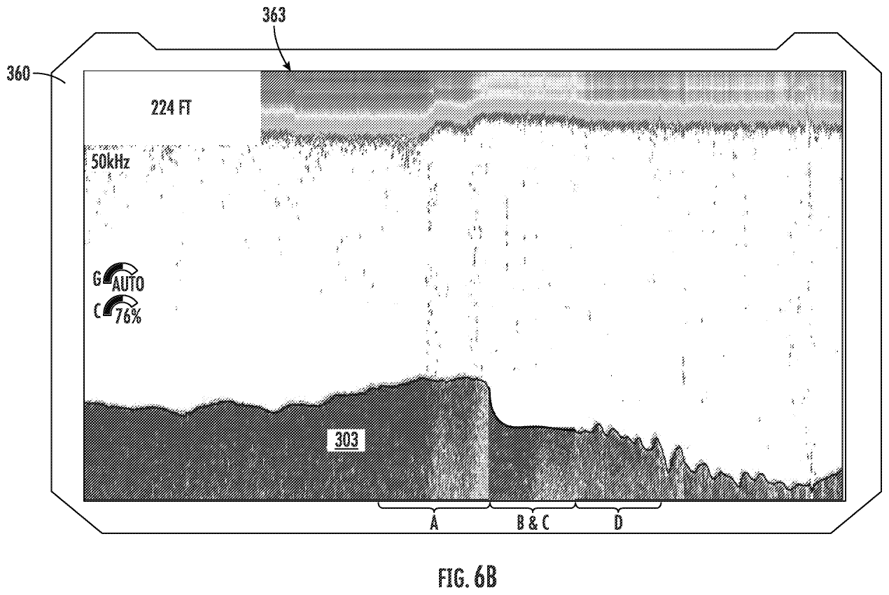

The geographically augmented sonar system may determine a depth at a location associated with travel of the watercraft to generate a continuous sonar image of the underwater environment being traversed. FIG. 6A illustrates a watercraft 300 traversing a body of water 301, wherein a bottom surface 303 exhibits a sudden depth change Δd. The watercraft may include a sonar transducer 302 configured to emit one or more sonar beams 310 into the underwater environment of the body of water 301 and receive sonar returns 314 generated by the one or more sonar beams 310 echoing off of the bottom surface of 303. As the watercraft 300 traverses, the system may determine the watercraft 300 is at a position defining a first depth d₁ and emit the one or more sonar beams 310 at a power output corresponding to the first depth d₁. The system may determine the watercraft 300 traversed over the sudden depth change Δd (e.g., by determining a stored or estimated depth at a location corresponding to the second depth d₂) and adjust the power output of the sonar transducer 302. Thus, the sonar transducer 302 may update the power output to emit one or more sonar beams 310′ at an updated power output to reach the bottom surface at a second depth d₂ to retain the bottom lock on the bottom surface 303.

The watercraft 300 may continue to traverse the body of water 301, such as in sections C-D and retain the bottom lock at the determined power output, thereby providing a reliable sonar image. FIG. 6B illustrates a marine electronics device 360 presenting a sonar image 362, depicting the bottom surface 303 of the body of water along the traverse of the watercraft over sections A-D. The sonar image 362 may present a continuous bottom surface 303 as the system predicted the sudden depth change Δd and adjusted the power output of the sonar transducer accordingly. Thus, rather than sections B-C being blank (see FIG. 3B) the sonar image 362 adequately depicts the bottom surface as the power output was correlated to the estimated depth or stored depth of the body of water at the position of the watercraft by the geographically augmented sonar system.

### Example System Architecture

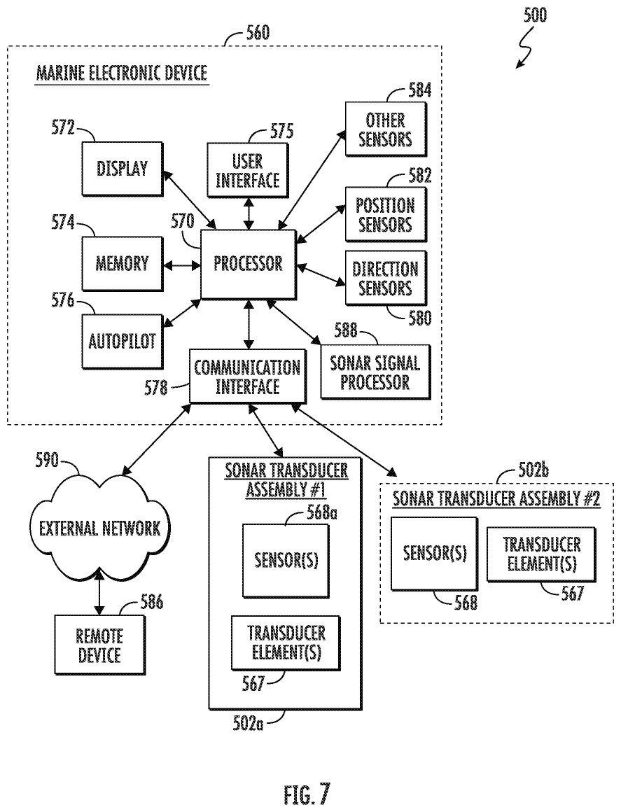

FIG. 7 illustrates a block diagram of an example system 500 according to various embodiments of the present invention described herein. The illustrated system 500 includes a marine electronic device 560. The system 500 may comprise numerous marine devices. As shown in FIG. 7, one or more sonar transducer assemblies 502a, 502b may be provided. One or more marine devices may be implemented on the marine electronic device 560. For example, a position sensor 582, a direction sensor 580, an autopilot 576, and other sensors 584 may be provided within the marine electronic device 560. These marine devices can be integrated within the marine electronic device 560, integrated on a watercraft at another location and connected to the marine electronic device 560, and/or the marine devices may be implemented at a remote device 586 in some embodiments. The system 500 may include any number of different systems, modules, or components; each of which may comprise any device or means embodied in either hardware, software, or a combination of hardware and software configured to perform one or more corresponding functions described herein.

The marine electronic device 560 may include at least one processor 570, a memory 574, a communication interface 578, a user interface 575, a display 572, autopilot 576, a sonar signal processor 588 and one or more sensors (e.g. position sensor 582, direction sensor 580, other sensors 584). One or more of the components of the marine electronic device 560 may be located within a housing or could be separated into multiple different housings (e.g., be remotely located).

The processor(s) 570 may be any means configured to execute various programmed operations or instructions stored in a memory device (e.g., memory 574) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the at least one processor 570 as described herein. For example, the at least one processor 570 may be configured to analyze sonar return data for various features/functions described herein (e.g., generate a sonar image, determine an object and/or object position, etc.).

In some embodiments, the at least one processor 570 may be further configured to implement signal processing. In some embodiments, the at least one processor 570 may be configured to perform enhancement features to improve the display characteristics of data or images, collect or process additional data, such as time, temperature, GPS information, waypoint designations, bathymetric data or others, or may filter extraneous data to better analyze the collected data. The at least one processor 570 may further implement notices and alarms, such as those determined or adjusted by a user, to reflect proximity of other objects (e.g., represented in sonar data), to reflect proximity of other vehicles (e.g. watercraft), approaching storms, etc.

In an example embodiment, the memory 574 may include one or more non-transitory storage or memory devices such as, for example, volatile and/or non-volatile memory that may be either fixed or removable. The memory 574 may be configured to store instructions, computer program code, sonar data, and additional data such as radar data, chart data, bathymetric data, location/position data in a non-transitory computer readable medium for use, such as by the at least one processor 570 for enabling the marine electronic device 560 to carry out various functions in accordance with example embodiments of the present invention. For example, the memory 574 could be configured to buffer input data for processing by the at least one processor 570. Additionally or alternatively, the memory 574 could be configured to store instructions for execution by the at least one processor 570.

The communication interface 578 may be configured to enable communication to external systems (e.g. an external network 590). In this manner, the marine electronic device 560 may retrieve stored data from a remote device 586 via the external network 590 in addition to or as an alternative to the onboard memory 574. Additionally or alternately, the marine electronics device 560 may store marine data locally, for example within the memory 574. Additionally or alternatively, the marine electronic device 560 may transmit or receive data, such as sonar signal data, sonar return data, sonar image data, or the like to or from a sonar transducer assembly 502a, 502b. In some embodiments, the marine electronic device 560 may also be configured to communicate with other devices or systems (such as through the external network 590 or through other communication networks, such as described herein). For example, the marine electronic device 560 may communicate with a propulsion system of the watercraft 100 (e.g., for autopilot control); a remote device (e.g., a user's mobile device, a handheld remote, etc.); or another system. Using the external network 590, the marine electronic device 560 may communicate with and send and receive data with external sources such as a cloud, server, etc. The marine electronic device 560 may send and receive various types of data. For example, the system may receive weather data, tidal data, data from other fish locator applications, alert data, depth data, among others. However, this data is not required to be communicated using external network 590, and the data may instead be communicated using other approaches, such as through a physical or wireless connection via the communications interface 578.

The communications interface 578 of the marine electronic device 560 may also include one or more communications modules configured to communicate with one another in any of a number of different manners including, for example, via a network. In this regard, the communications interface 578 may include any of a number of different communication backbones or frameworks including, for example, Ethernet, the NMEA 2000 framework, GPS, cellular, Wi-Fi, or other suitable networks. The network may also support other data sources, including GPS, autopilot, engine data, compass, radar, etc. In this regard, numerous other peripheral devices (including other marine electronic devices or sonar transducer assemblies) may be included in the system 500.

The position sensor 582 may be configured to determine the current position and/or location associated with travel of the marine electronic device 560 (and/or the watercraft 100). For example, the position sensor 582 may comprise a GPS, bottom contour, inertial navigation system, such as machined electromagnetic sensor (MEMS), a ring laser gyroscope, or other location detection system. Alternatively or in addition to determining the location of the marine electronic device 560 or the watercraft 100, the position sensor 582 may also be configured to determine the position and/or orientation of an object outside of the watercraft 100. In some embodiments, the position sensor 582 may be configured to determine a location associated with travel of the watercraft. For example, the position sensor 582 may utilize other sensors 584 (e.g., speed sensor, and/or direction sensor 580) to determine a future position of the watercraft 100 and/or a waypoint along the route of travel.

The display 572 (e.g. one or more screens) may be configured to present images and may include or otherwise be in communication with a user interface 575 configured to receive input from a user. The display 572 may be, for example, a conventional LCD (liquid crystal display), a touch screen display, mobile device, or any other suitable display known in the art upon which images may be displayed.

In some embodiments, the display 572 may present one or more sets of data (or images generated from the one or more sets of data). Such data includes chart data, radar data, sonar data, weather data, location data, position data, orientation data, sonar data, or any other type of information relevant to the watercraft. Sonar data may be received from one or more sonar transducer assemblies 502a, 502b or from sonar devices positioned at other locations, such as remote from the watercraft. Additional data may be received from marine devices such as a radar, a primary motor or an associated sensor, a trolling motor or an associated sensor, an autopilot 576, a rudder or an associated sensor, a position sensor 582, a direction sensor 580, other sensors 584, a remote device 586, onboard memory 574 (e.g., stored chart data, historical data, etc.), or other devices.

In some further embodiments, various sets of data, referred to above, may be superimposed or overlaid onto one another. For example, a route may be applied to (or overlaid onto) a chart (e.g. a map or navigational chart). Additionally or alternatively, depth information, weather information, radar information, sonar information, or any other navigation system inputs may be applied to one another.

The user interface 575 may include, for example, a keyboard, keypad, function keys, mouse, scrolling device, input/output ports, touch screen, or any other mechanism by which a user may interface with the system.

Although the display 572 of FIG. 7 is shown as being directly connected to the at least one processor 570 and within the marine electronic device 560, the display 572 could alternatively be remote from the at least one processor 570 and/or marine electronic device 560. Likewise, in some embodiments, the position sensor 582 and/or user interface 575 could be remote from the marine electronic device 560.

The marine electronic device 560 may include one or more other sensors/devices 584, such as configured to measure or sense various other conditions. The other sensors/devices 584 may include, for example, an air temperature sensor, a water temperature sensor, a current sensor, a light sensor, a wind sensor, a speed sensor, tide sensor, or the like.

The sonar transducer assemblies 502a, 502b illustrated in FIG. 7 may include one or more sonar transducer elements 567, such as may be arranged to operate alone or in one or more transducer arrays. In some embodiments, additional separate sonar transducer elements (arranged to operate alone, in an array, or otherwise) may be included. As indicated herein, the sonar transducer assemblies 502a, 502b may also include a sonar signal processor 588 or other processor (although not shown) configured to perform various sonar processing. In some embodiments, the processor (e.g., at least one processor 570 in the marine electronic device 560, a controller (or processor portion) in the sonar transducer assemblies 502a, 502b, or a remote controller— or combinations thereof) may be configured to filter sonar return data and/or selectively control transducer element(s) 567. For example, various processing devices (e.g., a multiplexer, a spectrum analyzer, A-to-D converter, etc.) may be utilized in controlling or filtering sonar return data and/or transmission of sonar signals from the transducer element(s) 567.

The sonar transducer assemblies 502a, 502b may also include one or more other systems, such as various sensor(s) 568. For example, the sonar transducer assembly 502a, 502b may include an orientation sensor, such as gyroscope or other orientation sensor (e.g., accelerometer, MEMS, etc.) that can be configured to determine the relative orientation of the sonar transducer assembly 502a, 502b and/or the one or more sonar transducer element(s) 567— such as with respect to a forward direction of the watercraft. In some embodiments, additionally or alternatively, other types of sensor(s) are contemplated, such as, for example, a water temperature sensor, a current sensor, a light sensor, a wind sensor, a speed sensor, or the like.

The components presented in FIG. 7 may be rearranged to alter the connections between components. For example, in some embodiments, a marine device outside of the marine electronic device 560, such as the radar, may be directly connected to the at least one processor 570 rather than being connected to the communication interface 578. Additionally, sensors and devices implemented within the marine electronic device 560 may be directly connected to the communications interface 578 in some embodiments rather than being directly connected to the at least one processor 570.

### Example Flowchart(s) and Operations

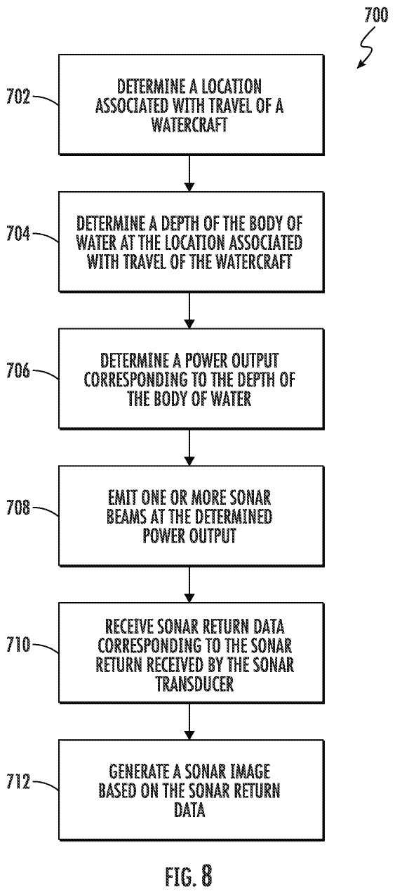

Some embodiments of the present invention provide methods, apparatus, and computer program products related to the presentation of information according to various embodiments described herein. Various examples of the operations performed in accordance with embodiments of the present invention will now be provided. FIG. 8 illustrates a flow chart with an example method for presenting marine data corresponding to geographically augmented sonar system according to various embodiments described herein. The method may be performed by a wide variety of components, including, but not limited to, one or more processors, one or more microprocessors, and one or more controllers. In some embodiments, a marine electronic device 560 (FIG. 7) may comprise one or more processors that perform the functions shown in FIG. 8. Further, various operations of the method may be provided on a piece of software which runs on a central server that is at a remote location away from the watercraft, and the remote server may communicate with a processor or a similar component on the watercraft. Additionally, the methods could be integrated into a software update that may be installed onto existing hardware, or the methods may be integrated into the initial software or hardware provided in a radar unit, watercraft, server, etc.

FIG. 8 is a flowchart of an example method 700 for generating a more continuous sonar image of an underwater environment, in accordance with some embodiments discussed herein. The operations illustrated in and described with respect to FIG. 8 may, for example, be performed by, with the assistance of, and/or under the control of one or more of the processor 570, memory 574, communication interface 578, user interface 575, position sensor 582, direction sensor 580, other sensor 584, autopilot 576, sonar signal processor 588 transducer assembly 502a, 502b, display 572, and/or external network 590/remote device 586.

At operation 702, the method 700 may comprise determining a location associated with travel of a watercraft. At operation 704, the method 700 may comprise determining a depth of the body of water at the location associated with travel of the watercraft. In some embodiments, determining the depth may include retrieving a stored depth at the location associated with travel of the watercraft, while in other embodiments, determining the depth may, additionally or alternatively, include estimating the depth of the body of water based on other known depths around the location associated with travel of the watercraft. At operation 706, the method 700 may comprise determining a power output corresponding to the depth of the body of water at the location associated with travel of the watercraft. At operation 708, the method 700 may comprise emitting one or more sonar beams at the determined power output. At operation 710, the method 700 may comprise receiving sonar return data corresponding to sonar returns received by the sonar transducer. At operation 712, the method 700 may comprise generating a sonar image based on the sonar return data.

FIG. 8 illustrates a flowchart of a system, method, and computer program product according to various example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 574 and executed by, for example, the processor 570. As will be appreciated, any such computer program product may be loaded onto a computer or other programmable apparatus (for example, a marine electronic device 560) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 560) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. A system for presenting marine data, the system comprising:
at least one sonar transducer associated with a watercraft, wherein the at least one sonar transducer is configured to emit one or more sonar beams into an underwater environment of a body of water in a direction relative to the watercraft;
a display;
a processor;
a memory including computer program code configured to, when executed, cause the processor to:
determine a location associated with travel of the watercraft;
determine a stored depth or an estimated depth of the body of water at the location, wherein the stored depth and the estimated depth are not based on a currently detected depth at the location;
determine, based on the stored depth or the estimated depth, a power output to apply for emitting the one or more sonar beams such that the at least one sonar transducer receives sonar returns from a bottom of the body of water;
emit the one or more sonar beams at the determined power output;
receive sonar return data corresponding to the sonar returns received by the at least one sonar transducer;
generate, based on the sonar return data, a sonar image corresponding to the sonar returns received by the at least one sonar transducer; and
cause, on the display, presentation of the sonar image.

2. The system of claim 1, wherein the location associated with travel of the watercraft is a current location of the watercraft.

3. The system of claim 1, wherein the location associated with travel of the watercraft is an anticipated location of the watercraft.

4. The system of claim 3, wherein the anticipated location is a waypoint along a route of travel.

5. The system of claim 1, wherein the location associated with travel of the watercraft is updated after a determining event.

6. The system of claim 5, wherein the determining event is one of a time interval or a distance traveled.

7. The system of claim 1, wherein the stored depth is gathered from at least one of a depth chart, an online database, or a prior depth reading.

8. The system of claim 1, wherein the estimated depth is estimated based on a first known depth at a first known location and a second known depth at a second known location, and wherein the location associated with travel of the watercraft is between the first known location and the second known location.

9. The system of claim 1, wherein the at least one sonar transducer is configured to emit the one or more sonar beams at a range of power outputs, and wherein the computer program code is configured to, when executed, cause the processor to:
determine, based on the range of power outputs of the at least one sonar transducer, the power output, such that the one or more sonar beams emitted are configured to reach the bottom of the body of water and return to the at least one sonar transducer.

10. The system of claim 1, wherein the computer program code is further configured to, when executed, cause the processor to:
receive tidal data to indicate a tidal stage of the body of water; and
adjust the stored depth or the estimated depth based on the tidal stage.

11. The system of claim 1, wherein the computer program code is further configured to, when executed, cause the processor to:
store the power output in a power output chart.

12. The system of claim 1, wherein the computer program code is further configured to, when executed, cause the processor to:
determine sonar returns have not been received after a period of time; and
increase the determined power output.

13. The system of claim 12, wherein the period of time is between 1-8 seconds.

14. A method for presenting marine data, the method comprising:
determining a location associated with travel of a watercraft, wherein the watercraft includes at least one sonar transducer configured to emit one or more sonar beams into an underwater environment of a body of water in a direction relative to the watercraft;
determining a stored depth or an estimated depth of the body of water at the location wherein the stored depth and the estimated depth are not based on a currently detected depth at the location;
determining, based on the stored depth or the estimated depth, a power output to apply for emitting the one or more sonar beams such that the at least one sonar transducer receives sonar returns from a bottom of the body of water;
emitting the one or more sonar beams at the determined power output;
generating, based on sonar return data, a sonar image corresponding to the sonar returns received by the at least one sonar transducer; and
causing, on a display, presentation of the sonar image.

15. The method of claim 14, wherein the location associated with travel of the watercraft is a current location of the watercraft.

16. The method of claim 14, wherein the location associated with travel of the watercraft is an anticipated location of the watercraft.

17. The method of claim 16, wherein the anticipated location is a waypoint along a route of travel.

18. The method of claim 14, further comprising:
associating the determined power output with the location associated with travel of the watercraft; and
storing the associated determined power output in a navigational chart.

19. A marine electronic device for a watercraft, the watercraft including at least one sonar transducer configured to emit one or more sonar beams into an underwater environment of a body of water in a direction relative to the watercraft, the marine electronic device comprising:
a display;
a processor;
a memory including computer program code configured to, when executed, cause the processor to:
determine a location associated with travel of the watercraft;
determine a stored depth or an estimated depth of the body of water at the location, wherein the stored depth and the estimated depth are not based on a currently detected depth at the location;
determine, based on the stored depth or the estimated depth, a power output to apply for emitting the one or more sonar beams such that the at least one sonar transducer receives sonar returns from a bottom of the body of water;
emit the one or more sonar beams at the determined power output;
receive sonar return data corresponding to the sonar returns received by the at least one sonar transducer;
generate, based on the sonar return data, a sonar image corresponding to the sonar returns received by the at least one sonar transducer; and
cause, on the display, presentation of the sonar image.

20. The marine electronic device of claim 19, wherein the location associated with travel of the watercraft is an anticipated location of the watercraft.
